(19) United States
(12) Patent Application Publication
(10) Pub. No.: US 2005/0186949 A1
(43) Pub. Date: Aug. 25, 2005

(54) Destination discovery in a wireless network

(75) Inventor: Jin-Meng Ho, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/051,354

(22) Filed: Feb. 4, 2005

Related U.S. Application Data
(60) Provisional application No. 60/542,171, filed on Feb. 5, 2004.

(51) Int. Cl. H04L 12/28; H04L 12/56

(52) U.S. Cl. 455/414.1; 455/414.2

(57) ABSTRACT

A method and apparatus for providing destination discovery in a wireless network by “press and play” allows for simple transfers of data such as streaming media between a source and a destination device. The transfer can occur directly between the devices or via a piconet controller (PNC). The destination discovery method is started by activating a RX button in a destination device and a TX button in the source device without requiring the user to explicitly specify the destination address. The destination device broadcasts discovery request commands and the source device responds with discovery response commands. An RXButton timeout timer and a TXButton timeout timer are used to control the discovery process.

### CROSS-REFERENCE TO RELATED APPLICATIONS

This application claims priority to U.S. Provisional Application No. 60/542,171 filed Feb. 5, 2004, and entitled “Streaming Destination Discovery in a Wireless Network-Press and Play,” by Jin-Meng Ho, which is incorporated herein by reference.

### FIELD OF THE INVENTION

This invention relates in general to the field of electronics and more particularly to a method and apparatus for streaming destination discovery in a wireless network.

### BACKGROUND OF THE INVENTION

In order to send a streaming application or file such as a video steam from one device to another device, a user has to specify the address of the destination unit. Typically this is accomplished by a user manually entering a URL address, or some other address information so the streaming application or file can be sent to the correct destination unit. Although acceptable for many situations, requiring a user to have to enter a destination address is time consuming and also requires a user to find or remember the address information for the destination device.

### BRIEF DESCRIPTION OF THE DRAWINGS

FIG. 1 shows a direct destination-source discovery in accordance with an embodiment of the invention.

FIG. 2 shows a PNC-relayed destination-source discovery sequence in accordance with an embodiment of the invention.

FIGS. 3A-3B illustrates a direct destination-source discovery in accordance with an embodiment of the invention.

FIGS. 4A-4B illustrates a relayed destination-source discovery in accordance with an embodiment of the invention.

FIG. 5 illustrates a discovery request command block format in accordance with an embodiment of the invention.

FIGS. 6-7 show discovery response command block format in accordance with an embodiment of the invention.

FIG. 8 shows a system in accordance with an embodiment of the invention.

### DETAILED DESCRIPTION OF THE PREFERRED EMBODIMENT

This invention uses a “press and play” method to enable a human user to send user data from a source device to a destination device in a wireless network. The invention allows for a source device to send a stream, file, etc., to a destination device in the presence of other similar or dissimilar devices without requiring the user to explicitly specify the destination address. Not requiring a user to discover or remember the address information for the destination address makes the process of data transfer much easier for the user.

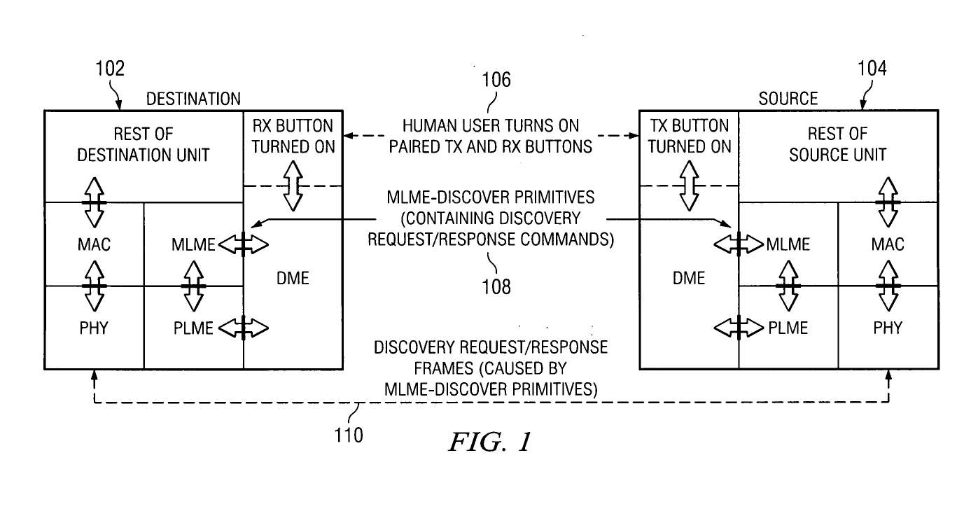

Referring now to the drawings and in particular to FIG. 1, there is shown a destination-source discovery system in accordance with an embodiment of the invention. The system supports IEEE 802.15 communications in one embodiment along with the added features provided by the present invention. It should be noted that other communication protocols can also be supported with the invention. A first electronic device or destination device 102 and a second electronic device or source device 104 are shown. The destination device 102 for example can comprise a television set or other electronic device. The destination device 102 includes a RX (receive) button (hereinafter referred to as a RX button) and portions of the device such as the Device Management Entity (DME), Physical (PHY) Layer, Physical Layer Management Entity (PLME), Medium Access Control (MAC) Sublayer, and MAC subLayer Management Entity (MLME) are also shown. The source device 104 includes a transmit button (hereinafter referred to as a TX button) and comprises as an illustrative example a DVD player or other electronic device and similar portions to those in the destination device 102.

In accordance with an embodiment of the invention, when a user wants the source device 104 to send a file or streaming data to the destination device 102, the user in 106 activates both a RX button in the destination device 102 and a TX button in the source device 104. Preferably the TX button is activated first before the RX button, but this is not necessary. Turning on the TX or RX buttons is indicated to the local device's DME. In response to the indication that the TX or RX button has been activated, the respective DME sets up a TXbutton timeout or RXbutton timeout timer after the TX button or RX button is turned on, respectively. The destination device 102 and the source device 104 can for example have up to 4 TX buttons (TX1, TX2, TX3 and TX4) and up to 4 RX buttons (RX1, RX2, RX3 and rX4). The number of buttons can depend on the particular system design requirements.

The destination device 102 broadcasts Discovery Request commands and the source device 104 responds with Discovery Response commands. The DME feeds back the discovery result to the TX/RX button interface. The DME provides either a positive or negative discovery result to the RX button user interface, but preferably only a positive discovery result (when available) to the TX button user interface. A positive result may be indicated by for example a dial tone sound or green light, etc., while a negative result may be indicated by a busy tone sound or a flashing red light. Other audio/visual responses may also be provided depending on the particular system design requirements.

In 108, MLME discovery primitives that can include Discovery Request/Response commands are transferred between the DME and the MLME. Once a link is established, Discovery Request/Response command frames are transferred between the PHY layers in the destination 102 and source 104 devices as shown in 110.

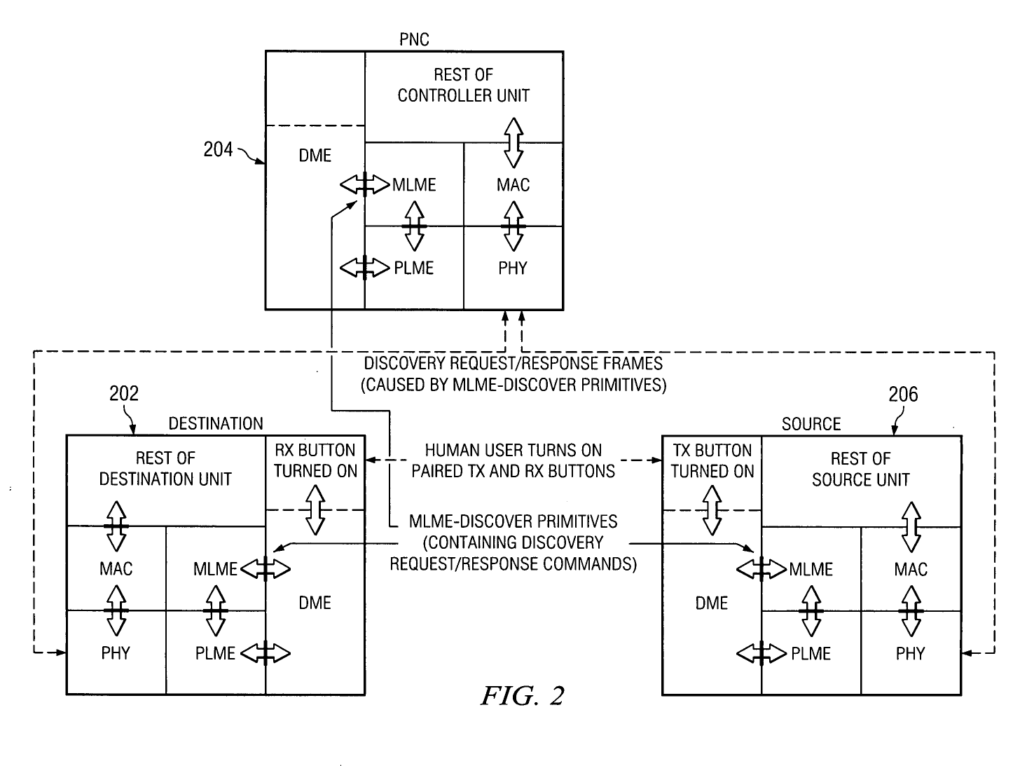

In FIG. 2 there is shown a similar system as shown in FIG. 1, except that communications between a destination device 202 and source device 206 occurs using a piconet controller (PNC) 204. Again in order to start the discovery process a user activates the RX button on the destination device 202 and the TX button on the source device 206. After the MLME discover primitives are exchanged within the destination 202 and source devices 206, the PHY layer in the PNC 204 relays the transfer of data between the PHY layer of the destination device 202 and the PHY layer of the source device 206.

Destination Broadcast

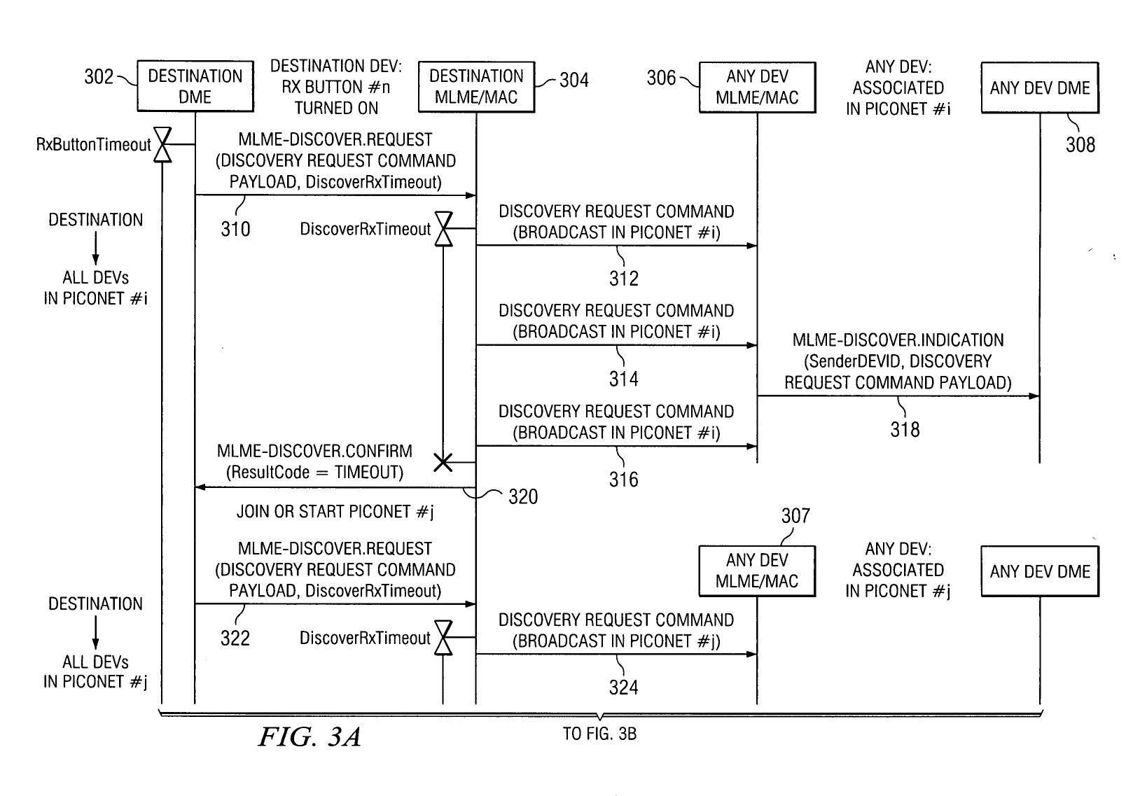

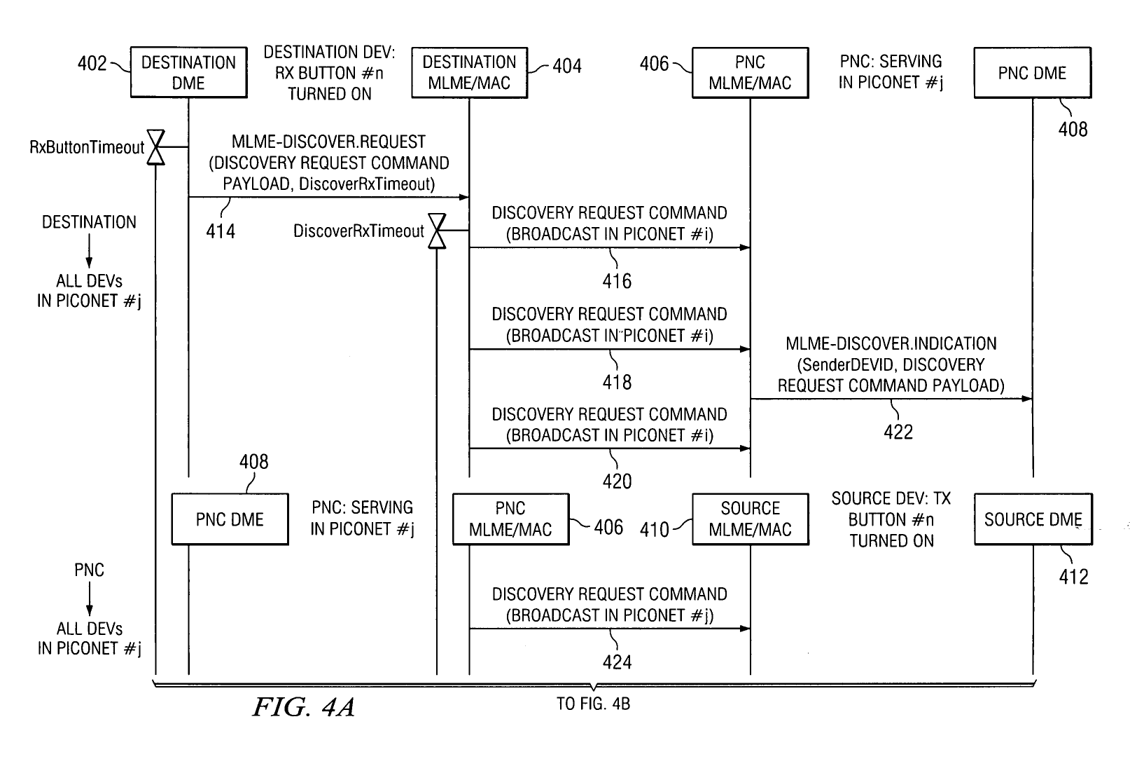

As shown in FIGS. 3A and 3B after an RX button is turned on, the destination device DME 302 issues to the destination MLME/MAC 304 an MLME-DISCOVER.request 310, 322 and the MAC 304 broadcasts a Discovery Request command 312, 314, 316, 324, 326, 328 in piconet # i and piconet # j to any device (DEV) MLME/MAC 306 and 307 as an example and the source MLME/MAC 340. The MLME-DISCOVER.request primitive contains such parameters as a Discovery Request command payload and a DiscoverRxTimeout. The command payload contains a RX Button Number (1 octet), Destination device ID (1 octet), Destination Address (8 octets), Destination PNID (1 octet), and Destination PNC Address (8 octets). The command is preferably not encrypted. An example of a Discovery Request command block format is shown in FIG. 5.

The device forms a new piconet (e.g., piconet # j) to send the command RxWaitTime after the RX button is turned on following a failure to find an existing piconet and associate with a PNC if it was not associated with a PNC or a PNC itself at the time the RX button was turned on was not found. The RxWaitTime allows the source device of the stream to be a PNC if needed.

The MAC broadcasts and re-broadcasts the Discovery Request command 324-328 in the contention access period (CAP) using Carrier Sense Multiple Access with Collision Avoidance (CSMA/CA) and in an open Management Channel Time Allocation (MCTA) in the channel time allocation period (CTAP) using slotted Aloha. Each of the re-broadcasts 314, 316, 326, 328 is considered to be a retry in setting backoff counters, while CSMA/CA and slotted Aloha are considered independent in counting retries.

Destination Reception

The MAC 304 stops rebroadcasting this command once a valid Discovery Response command 332 is received or a DiscoveryRxTimeout 320 is reached. A received Discovery Response command 330 is considered valid if it passes the appropriate security validation such as passing an integrity code validation. In order to perform security validation on such a command, the MAC may use a source device ID (Source DEVID) found in the command payload.

The MLME 304 issues an MLME-DISCOVER.confirm primitive 320, 330 which contains a ResultCode of TIMEOUT, or a SenderDEVID, a Discovery Response command payload and a Result Code of SUCCESS. The Sender DEVID is the SrcID in the received Discovery Response command. If the ResultCode is TIMEOUT, the SenderDEVID and the Discovery Response command payload are null. If the ResultCode is TIMEOUT, as caused by the expiration of a DiscoveryRxTimeout timer but the RxButtonTIMEOUT timer has not expired, the DME instructs the MAC to join or start another piconet. The procedure then repeats until the destination device receives a valid Discovery Repsonse command or the RxButtonTimeout timer expires. The RxButtonTimeout timer was set when the local DME was signaled that a RX button of the destination device was pressed. The DiscoveryRxTimeout timer was set after the destination MLME received a MLME-DISCOVER.request primitive. Preferably, the RxButton Timeout timer is set to be greater than the DiscoveryRxTimeout timer.

When a ResultCode of SUCCESS is received or the RxButtonTimeout timer expires, the destination DME 302 provides a positive or negative result, respectively to the RX button user interface. The destination device turns off the RX button when the RxButtonTimeout timer expires.

Source Reception

After a TX button is turned on, the source device should form a new piconet if it is not associated with a PNC or serving as a PNC. If the source device's MAC receives a valid Discovery Request command, the MLME will issue an MLME-DISCOVER.indication primitive 318, 336. A received Discovery Request command 326 is considered valid if it passes the appropriate security validation, for example passes an integrity code validation. To perform security validation on such a command, the MAC uses the source DEVID included in the Discovery Request command payload in lieu of the SrcID field in the command frame header. The primitive 336 contains a SenderDEVID and the received Discovery Request command payload. The SenderDEVID is the SrcID in the received Discovery Request command.

If no TX button is on, the source device's DME 308 will not process any MLME-DISCOVER.indication primitive. A TX button is turned off by the source device after being turned on for a TxButtonTimeout time.

Source Response

While a TX button is on, upon receipt of an MLME-DISCOVER.indication including a matched RX Button Number, the source device's DME 342 issues to the MLME 340 a MLME-DISCOVER.response primitive 338 and the source MAC 340 sends a Discovery Response command 332 to the destination MAC. 304 An immediate acknowledgment (IMM-ACK) 334 is sent by the destination MLME/MAC 304 to acknowledge receipt of this command. The issued primitive includes a Discovery Response command payload that contains a TX Button Number (1 octet), Destination device ID (DEVID, 1 octet), Destination Address (8 octets), Destination PNID (1 octet), Destination PNC Address (8 octets), Source DEVID (1 octet), Source Address (8 octets), Source PNID (1 octet), Source PNC address (8 Octets) and application specific data. The command is preferably not encrypted, but will be authenticated with an integrity code calculated as if the DestID field were the Destination DEVID included in the command payload.

After issuing an MLME-DISCOVER.response 338, the source device's DME proceeds to request CTA for the pending stream if the device is not a PNC. The DME uses the destination DEVID in the received Discovery Request command as the DestID for the pending stream. When the CTA is set up, the DME provides a positive result to the TX button user interface.

Destination-PNC-Source Relay

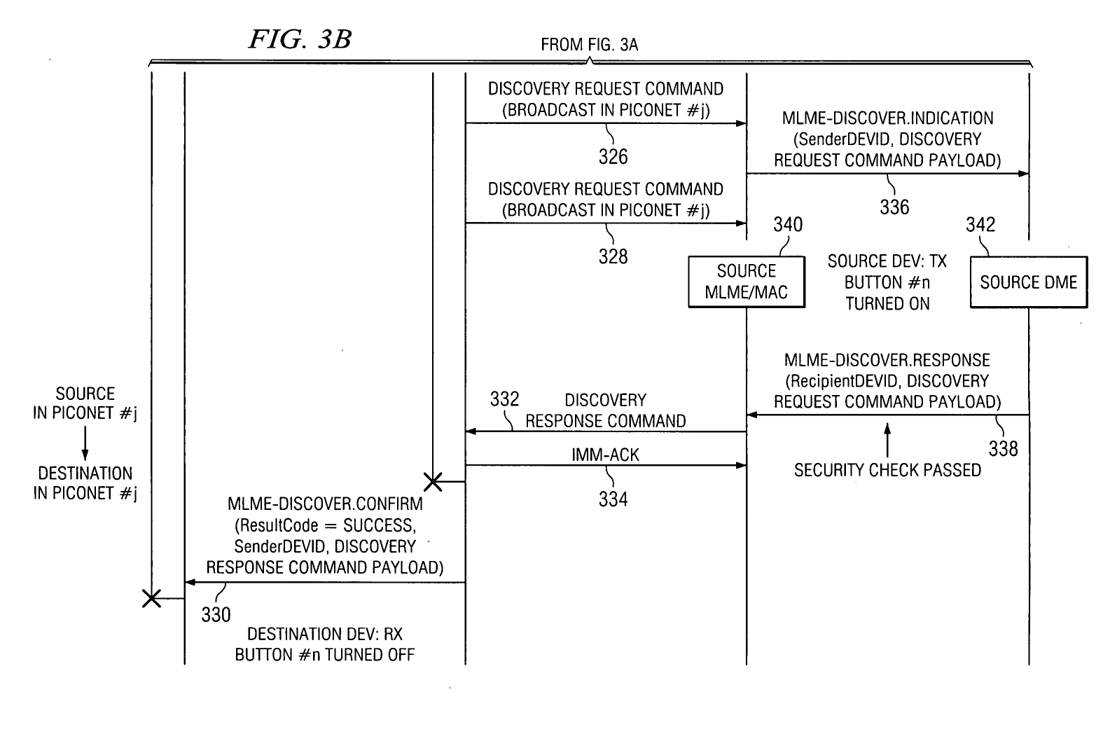

As shown in the Destination to PNC to Source example in FIGS. 4A and 4B, when a RX button is turned on, the destination DME 402 sends an MLME-DISCOVER.request command 414 to the destination MLME/MAC 404, which then broadcasts a Discovery Request command 416, 418, 420, 424, 426, 428 in piconet # i and piconet # j as described before. An illustrative Discovery Request command block format is shown in FIG. 5.

When a PNC MAC 406 receives a Discovery Request command 416, 418, 420, it rebroadcasts the command mDISCOVERYPNC times. The PNC does not need to securely validate the received command. The PNC changes the SrcID field to the PNCID (0×00) for rebroadcast. If the command payload is the same as in an earlier rebroadcast command, the PNC will not rebroadcast such a command.

If the source device's MAC 410 receives a valid Discovery Request command 426, the MLME 410 will issue an MLME-DISCOVER.indication primitive 430. A received Discovery Request command is considered valid if it passes the appropriate security validation (e.g., integrity code validation.) To perform security validation on such a command, the MAC uses the Source DEVID included in the command payload in lieu of the SrcID field in the command frame header. The primitive contains a SenderDEVID and the received Discovery Reqeust command payload. The SenderDEVID is the SrcID in the received Discovery Request command. If not TX button is on, the DME will not process any MLME-DISCOVER.indication primitive.

Source-PNC-Destination Relay

When a TX button is on, upon receipt of an MLME-DISCOVER.indication containing a matched RX Button Number, the source device's DME 412 issues to the MLME 410 an MLME-DISCOVER.response primitive 438 and the source MAC 410 sends a Discovery Response command 434 to the relaying PNC MAC 406. The command is acknowledged (IMM-ACK 436) by the PNC MAC 406. The issued primitive contains a RecipientDEVID and the Discovery Response command payload. The RecipientDEVID is the SenderDEVID in the received Discovery Request command, and is the SrcID for the Discovery Response command.

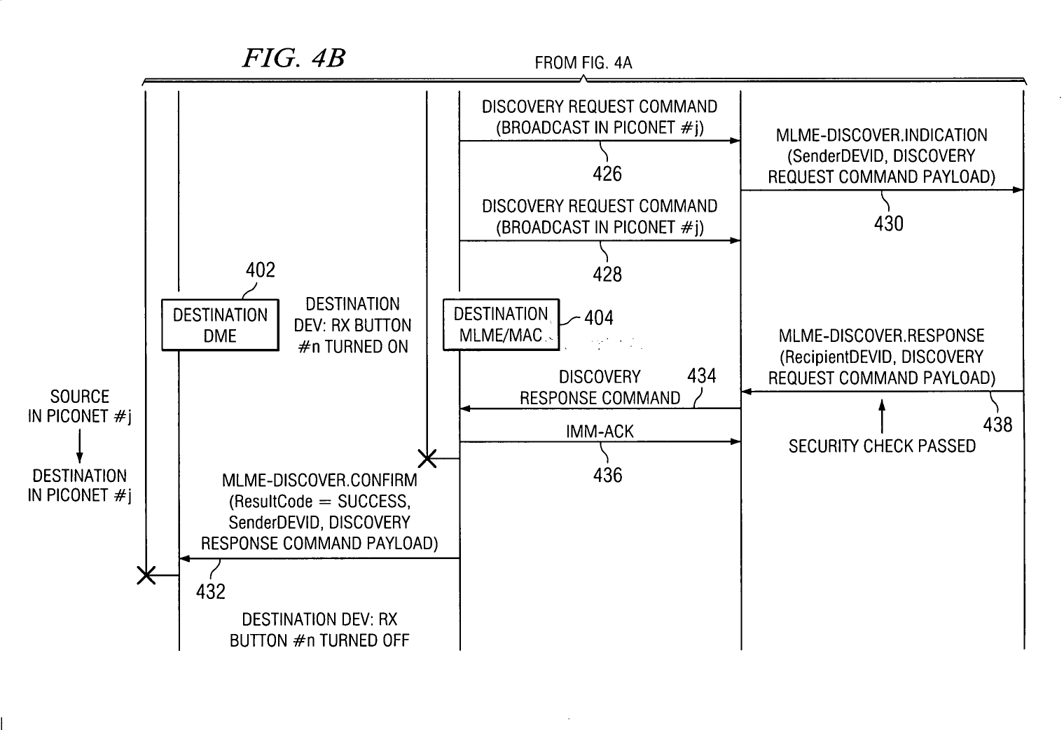

The Discovery Response command payload contains a TX Button Number (1 octet), Destination DEVID (1 octet), Destination Address (8 octets), Destination PNID (1 octet), Destination PNC Address (8 octets), Source DEVID (1 octet), Source Address (8 octets), Source PNID (1 octet), Source PNC address (8 octets), and application specific data. The command payload is preferably not encrypted, but is authenticated as if the DestID field were the Destination DEVID included in the command payload. An illustrative Discovery Response command block format is shown in FIGS. 6 and 7.

When a PNC receives a Discovery Response command 434, it forwards the command to the destination device as identified by the Destination DEVID. The PNC does not need to securely validate the received command. The PNC changes the SrcID field to the PNCID (0×00) and the DestID field to the Destination DEVID in the received command payload. A MLME-DISCOVER.confirm with a RsultCode=SUCCESS 432 is sent from the destination MLME/MAC 404 to the destination device DME 402.

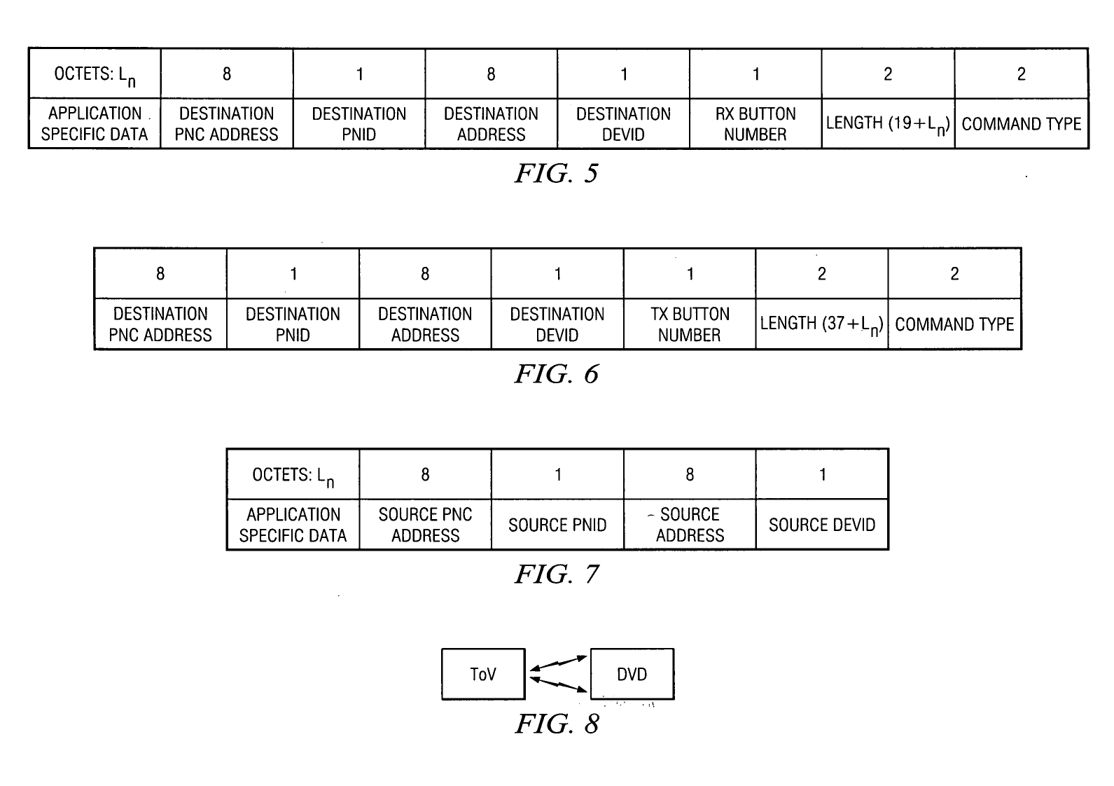

An illustrative destination and source device system using the destination discovery technique of the present invention is shown in FIG. 8. In the example shown, a destination device comprises a television (TV) and the source device comprises a digital video recoreder (DVD). Using the present technique described above, the DVD can find the TV so that it can send it streaming media such as video data that is to be displayed on the TV.

Although illustrative embodiments of the invention have been described above, they do not limit the scope of the invention, which can be practiced in a variety of embodiments. Numerous variations and modifications will become apparent to those skilled in the art. It is intended that the following claims be interpreted to embrace all such variations and modifications.

1. A method for destination device discovery in a wireless network including a destination device and a source device, comprising:
activating a RX button in the destination device;
activating a TX button in the source device;
broadcasting a discovery request command from the destination device; and
transmitting a discovery response command from the source device.

2. A method as defined in claim 1, further comprising:
setting a RX button timeout timer upon the activation of the RX button; and
setting a TX button timeout timer upon the activation of the TX button.

3. A method as defined in claim 1, wherein the activating of the RX button and the TX button is performed using a remote control.

4. A method as defined in claim 1, wherein the discovery request command and the discovery response command are relayed via a piconet controller (PNC).

5. A method as defined in claim 1, wherein the discovery request command includes the following parameters: RX button number, destination DEVID, Destination address, destination PNID and Destination PNC address.

6. A method as defined in claim 1, wherein the broadcasting of the discovery request command is halted once a valid discovery response command is received at the destination device.

7. A method as defined in claim 2, wherein the broadcasting of the discovery request command is halted once the RX button timeout timer expires.

8. A method as defined in claim 1, further comprising:
forming a new piconet by the source device after the TX button is activated if the source device is neither associated with a piconet controller (PNC) nor serving as a PNC.

9. A method as defined in claim 5, wherein the source device transmits the discovery response command only if a matched RX button number is received.

10. A method as defined in claim 1, further comprising:
rebroadcasting the discovery request command if it is received by a piconet controller (PNC).

11. A wireless communication system, comprising:
a destination device having a RX button;
a source device having a TX button; and
the destination device upon the activation of the RX button broadcasting a discovery request command and the source device upon the receipt of the discovery request command that includes a matching RX button number transmiting a discovery response command to the destination device in order to establish communication between the source and destination devices.

12. A wireless communication system as defined in claim 11, wherein the destination device upon activation of the RX button starts a discovery RX timeout timer.

13. A wireless communication system as defined in claim 12, wherein upon the discovery RX timeout timer expiring and no discovery response command being received at the destination device, the destination device starts broadcasting discovery request commands in a new piconet.

14. A wireless communication system as defined in claim 12, wherein the destination device halts broadcasting discovery request commands upon the discovery RX timeout timer expiring.

15. A wireless communication system as defined in claim 11, further comprising:
a remote control, the remote control activating the RX and TX buttons.

16. A destination device, comprising:
a RX button;
a device management entity (DME) coupled to the RX button;
a Medium Access Control (MAC) sublayer and a MAC sublayer management entity (MLME) coupled to the DME; and
the DME sending a MLME-DISCOVER request to the MLME/MAC that causes the MLME/MAC to broadcast a discovery request command.

17. A destination device as defined in claim 16, further comprising:
a discovery RX timeout timer; the discovery RX timeout timer being set when the DME sends the MLME-DISCOVER.request to the MLME/MAC.

18. A destination device as defined in claim 17, further comprising:
a physical (PHY) layer for transferring request/response frames once a link is established with a source device.

19. A destination device as defined in claim 17, wherein a link is established with a source device if the MLME/MAC receives a discovery response command from the source device prior to the discovery RX timeout timer expiring.

20. A destination device as defined in claim 17, wherein the destination device broadcasts the discovery request command in a different piconet if the discovery RX timeout timer expires prior to a discovery response command being received by the MLME/MAC.
